(19) United States
(12) Patent Application Publication
(10) Pub. No.: US 2007/0189635 A1
(43) Pub. Date: Aug. 16, 2007

(54) Method for noise reduction in imaging methods

(76) Inventors: Anja Borsdorf, Hochstadt (DE); Rainer Raupach, Adelsdorf (DE)

Correspondence Address: HARNESS, DICKEY & PIERCE, P.L.C., P.O.BOX 8910, RESTON, VA, 20195, US

(21) Appl. No.: 11/703,243

(22) Filed: Feb. 7, 2007

(30) Foreign Application Priority Data
Feb. 8, 2006 (DE) 10 2006 005 803.8

(51) Int. Cl. G06K 9/40; G06K 9/00

(52) U.S. Cl. 382/275; 382/128; 382/260

(57) ABSTRACT

A method for noise reduction in imaging methods is disclosed. In at least one embodiment, two statistically independent image data records in the same situation are generated, are subjected to wavelet transformation characterized by a low-pass filter and a high-pass filter, the correlation between the independent image data records is determined from respectively corresponding wavelet coefficients, and during the back transformation, wavelet coefficients with less correlation are given a lower weighting than wavelet coefficients with greater correlation. Further, the rating of the correlations and the weighting of the wavelet coefficients during the back transformation in the case of wavelet coefficients which have been produced through a combination of high-pass and low-pass filtering are independent of the rating of the correlations and the weighting of the wavelet coefficients during the back transformation of the wavelet coefficients which have been produced through pure high-pass filtering.

### PRIORITY STATEMENT

The present application hereby claims priority under 35 U.S.C. §119 on German patent application number DE 10 2006 005 803.8 filed Feb. 8, 2006, the entire contents of each of which is hereby incorporated herein by reference.

### FIELD

Embodiments of the invention generally relate to methods for noise reduction in imaging methods. For example, they may relate to one where at least two statistically independent image data records which have the same dimensions and are in the same situation are generated and are respectively subjected to wavelet transformation with low-pass filtering and high-pass filtering over a number j of levels, and the correlation between the at least two statistically independent image data records is determined from a cross correlation function for the respectively corresponding wavelet coefficients of the at least two image data records, and during back transformation of an image data record from at least one wavelet data record, wavelet coefficients with less correlation are given a lower weighting than wavelet coefficients with greater correlation.

### BACKGROUND

The principle of wavelet transformation in the course of image conditioning is universal. With regard to wavelet transformation, reference is made by way of example to the Internet page http://de.wikipedia.org/wiki/Wavelet. This location provides further references relating to the theory of wavelet transformation.

Laid-open specification DE 103 05 221 A1 discloses a method for noise rejection. This document ascertains the correlations between two statistically independent, identical or spatially similar shots from the cross correlation function of particular wavelet coefficients. This clearly corresponds to the normalized scalar product of the vectors formed from the two “directional derivations” for the j-th wavelet level,

$${κ}_{j} = \frac{{W}_{{A}_{j}}^{x} {W}_{{B}_{j}}^{x} + {W}_{{A}_{j}}^{y} {W}_{{B}_{j}}^{y}}{\sqrt{{( {W}_{{A}_{j}}^{x} )}^{2} + {( {W}_{{A}_{j}}^{y} )}^{2}} \sqrt{{( {W}_{{B}_{j}}^{x} )}^{2} + {( {W}_{{B}_{j}}^{y} )}^{2}}} .$$

Depending on the wavelet used, however, such shots also contain patterns which have tiny directional derivations and are nevertheless correlated. As a result of the components which are remote despite correlation with respect to real structures, image artifacts arise in the form of this pattern on various length scales depending on the level under consideration in the wavelet transformation. With a tiny or small standard for the vector formed from the directional derivations, the form shown in the specification DE 103 05 221 A1 cannot be used to make a reliable statement about the presence of correlated structures. In addition, diagonal components with a high level of correlation may exist despite a small cross correlation function.

### SUMMARY

In at least one embodiment of the invention, an improved method is disclosed for noise rejection in imaging which cancels out actually existing structures during conditioning less often.

Accordingly, the inventors propose improving, in at least one embodiment, the method for noise reduction in imaging methods. The method comprises,
at least two statistically independent image data records which have the same dimensions and are in the same situation are generated,
the at least two statistically independent image data records (A, B) are respectively subjected to wavelet transformation with low-pass filtering and high-pass filtering over a number j of levels, where:
   four groups of wavelet coefficients are calculated in each level,
   a TP group of wavelet coefficients is formed by TPXTP operations,
   an HP group of wavelet coefficients is formed by HPXHP operations, and
   two hybrid groups of the wavelet coefficients are formed by TPXHP operations on the one hand and HPXTP operations on the other hand,
the correlation between the at least two statistically independent image data records is determined from a cross correlation function for the respectively corresponding wavelet coefficients of the at least two image data records, and
during back transformation of an image data record from at least one wavelet data record, wavelet coefficients with less correlation are given a lower weighting than wavelet coefficients with greater correlation.

In line with at least one embodiment of the invention, the inventors propose one improvement to the effect that the rating of the correlations and the weighting of the wavelet coefficients during the back transformation within the hybrid groups of the wavelet coefficients differ from the rating of the correlations and the weighting of the wavelet coefficients during the back transformation within the HP group of wavelet coefficients.

This improved method for noise rejection, in at least one embodiment, now allows, through appropriate rating and weighting, actually existing structures to be cancelled out less often during conditioning, while at the same time it is possible to reduce the noise in optimum fashion.

In addition, it should be pointed out that the independent image data records which have the same dimensions and are in the same situation are to be understood to mean statistically independent shot data from an object under the same to very similar conditions or under conditions which have been slightly altered in a known manner. Also, the image data to be compared need to be in the same number of spatial dimensions so that mutually corresponding wavelet coefficients can be calculated and compared with one another during the transformation.

In practice, it is particularly beneficial if, during the wavelet transformation, the image data record from the first group is taken as a basis for calculating the next level, and in each level the volume of data in the first group is reduced to one quarter of the initial volume of data.

When weighting the wavelet coefficients during the back transformation, the HP groups can be placed higher than the weighting for the wavelet coefficients of the hybrid groups, that is to say the two HPXTP and TPXHP groups. In this case, TP and HP are the low- and high-pass filters associated with the wavelet transformations, with the following groups of wavelet coefficients being produced during wavelet breakdown for a level:

| | |
|---|---|
| TP × TP | TP × HP |
| HP × TP | HP × HP |

(for reasoning, see above). The wavelet breakdown is advantageously calculated only up to a level jₘₐₓ, since the dominant contributions to the noise power come from the high frequencies.

It is also advantageous for the correlation function Kⱼ^{TP,HP} used within the TPXHP group to be the function

$${κ}_{j}^{TP , HP} = {( \frac{{W}_{{A}_{j}}^{TP \times HP} {W}_{{B}_{j}}^{TP \times HP} + {W}_{{A}_{j}}^{HP \times TP} {W}_{{B}_{j}}^{HP \times TP}}{\sqrt{{( {W}_{{A}_{j}}^{TP \times HP} )}^{2} + {( {W}_{{A}_{j}}^{HP \times TP} )}^{2}} \sqrt{{( {W}_{{B}_{j}}^{TP \times HP} )}^{2} + {( {W}_{{B}_{j}}^{HP \times TP} )}^{2}}} )}^{{P}_{1}} ,$$

where the variables are as follows:
W_{A}_{ⱼ}^{TPxHP}=wavelet coefficient of the image data record A in the level j of the hybrid group TPXHP;
W_{B}_{ⱼ}^{TPxHP}=wavelet coefficient of the image data record B in the level j of the hybrid group TPXHP;
W_{A}_{ⱼ}^{HPxTP}=wavelet coefficient of the image data record A in the level j of the hybrid group HPXTP;
W_{B}_{ⱼ}^{HPxTP}=wavelet coefficient of the image data record B in the level j of the hybrid group HPXTP;
P₁=variable for setting the degree of selection.

Similarly, it is beneficial in the specific case for the correlation function κⱼ^{HP,HP} used within the HP group to be the function

$${κ}_{j}^{HP , HP} = \frac{1}{2} + {( \frac{{W}_{{A}_{j}}^{HP \times HP} {W}_{{B}_{j}}^{HP \times HP}}{{( {W}_{{A}_{j}}^{HP \times HP} )}^{2} + {( {W}_{{B}_{j}}^{HP \times HP} )}^{2}} )}^{{P}_{2}} ∈ [ 0 , 1 ] ,$$

where the variables are as follows:
W_{A}_{ⱼ}^{HPxHP}=wavelet coefficient of the image data record A in the level j of the HP group;
W_{B}_{ⱼ}^{HPxHP}=wavelet coefficient of the image data record B in the level j of the HP group; P₂=variable for setting the degree of selection.

It should be noted in particular that the inventive method, in at least one embodiment, is not a simple generic generalization of the known method from the specification DE 103 05 221 A1. With such a generalization, the correlation functions would merely be expanded as follows:

$$\frac{{W}_{{A}_{j}}^{TP \times HP} {W}_{{B}_{j}}^{TP \times HP} + {W}_{{A}_{j}}^{HP \times TP} {W}_{{B}_{j}}^{HP \times TP}}{\sqrt{{( {W}_{{A}_{j}}^{TP \times HP} )}^{2} + {( {W}_{{A}_{j}}^{HP \times TP} )}^{2}} \sqrt{{( {W}_{{B}_{j}}^{TP \times HP} )}^{2} + {( {W}_{{B}_{j}}^{HP \times TP} )}^{2}}} \to \frac{\begin{matrix}{W}_{{A}_{j}}^{TP \times HP} {W}_{{B}_{j}}^{TP \times HP} + \\ {W}_{{A}_{j}}^{HP \times TP} {W}_{{B}_{j}}^{HP \times TP} + {W}_{{A}_{j}}^{HP \times HP} {W}_{{B}_{j}}^{HP \times HP}\end{matrix}}{\begin{matrix}\sqrt{{( {W}_{{A}_{j}}^{TP \times HP} )}^{2} + {( {W}_{{A}_{j}}^{HP \times TP} )}^{2} + {( {W}_{{A}_{j}}^{HP \times HP} )}^{2}} \\ \sqrt{{( {W}_{{B}_{j}}^{TP \times HP} )}^{2} + {( {W}_{{B}_{j}}^{HP \times TP} )}^{2} + {( {W}_{{B}_{j}}^{HP \times HP} )}^{2}}\end{matrix}}$$

In this case, however, correlation functions are rated independently according to the group of correlation functions which is under consideration, and additionally the correlation coefficients are weighted independently during the back transformation.

It is particularly beneficial, particularly in respect of rapid data processing, if a Haar wavelet is used for the wavelet transformation. In principle, however, it is also possible to use any other known wavelets, such as those specified at http://de.wikipedia.org/wiki/Wavelet, for example spline or Daubechy wavelets. The specific embodiments of this application relate entirely to Haar wavelets, however.

On account of the ionizing property of radiations which are used, for example X-ray radiation or Positron Emission Radiation, which is used to scan patients or to locate tissue parts, and the accompanying risk regarding cell deterioration, these methods always involve attempts to perform the examinations at as low a dose as possible, because the small available dose when scanning the patients means that the existing quantum noise takes on a high level of relevance for the image quality and adversely affects the image quality through a correspondingly high level of image noise. It is therefore particularly advantageous to apply the embodiments of the inventive method in conjunction with imaging by ionizing radiation. This allows the dose to be kept down while image quality remains the same.

Accordingly, it is particularly advantageous to apply the described method, in at least one embodiment, in X-ray computer tomography. Firstly, the independent image data records used in a sectional plane may be at least two statistically independent sectional images. Secondly, the at least two statistically independent image data records used may also be two statistically independent projection data records from which a noise-free projection data record is generated and noise-free projection data records ascertained in this manner are used to reconstruct sectional images. For this application, reference is made to the previously unpublished German patent application with the file reference DE 10 2005 012 654.5, and its disclosed content, particularly with regard to the application variants of correlation analyses for noise rejection, the entire contents of which are hereby incorporated herein by reference.

Finally, reference is also made to the fact that the inventive method, in at least one embodiment, can also be applied to transmission X-ray images, where identical images of an object which are generated statistically independently from one another are examined for their correlation behavior and are conditioned in the manner described above.

In Positron Emission Tomography (PET) or when producing scintigrams, for example of the thyroid, too, the method described, in at least one embodiment, can be used in dose-saving fashion, since it also allows a reduction in the quantity of radioactive substances which are to be administered.

In the realm of NMR tomography (NMR=Nuclear Magnetic Resonance), ultrasound reflection imaging or ultrasound tomography, the method, in at least one embodiment, is suitable for improving image quality.

### BRIEF DESCRIPTION OF THE DRAWINGS

Embodiments of the invention are described in more detail below using the specific example of CT imaging with reference to the figures, where only the features which are required to understand the embodiments of the invention are shown and the following reference symbols are used: 1: CT system; 2: first X-ray tube; 3: first multirow detector; 4: second X-ray tube; 5: second multirow detector; 6: gantry housing; 7: patient; 8: patient's couch; 9: system axis; 10: processor; 11: memory; 12: image data records; 13: statistically independent subordinate image data records; 14: wavelet transformation; 15: calculation of the cross correlation coefficients; 16: reformatting; 17: new image data record; 18: illustration of an embodiment of the inventive method; Prgₙ: computer program.

Specifically:

FIG. 1 shows a convolution core for the Haar wavelet for first directional derivation, TPxHP group;

FIG. 2 shows a convolution core for the Haar wavelet for first directional derivation, HPxTP group;

FIG. 3 shows a convolution core for the Haar wavelet for diagonal derivation, HPxHP group;

FIG. 4 shows a first pixel pattern which has a tiny directional derivation when the Haar wavelet is used;

FIG. 5 shows a second pixel pattern which has a tiny directional derivation when the Haar wavelet is used;

FIG. 6 shows an axial CT image;

FIG. 7 shows the CT image from FIG. 6 with noise removed using a method from the patent application with the file reference DE 10 2005 012 654.5 (incorporated herein by reference);

FIG. 8 shows the difference image from FIG. 7 minus FIG. 6;

FIG. 9 shows the CT image from FIG. 6 with noise removed using an embodiment of the inventive method;

FIG. 10 shows the difference image from FIG. 9 minus FIG. 6;

FIG. 11 shows a CT system with a schematic illustration of an embodiment of the inventive method.

### DETAILED DESCRIPTION OF THE EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

The specification DE 103 05 221 A1 proposes ascertaining correlations between two statistically independent, identical or spatially similar shots, that is to say reconstructed image or projection data, using the cross correlation function for particular wavelet coefficients. This clearly corresponds to the normalized scalar product of the vectors formed from the two “directional derivations” for the j-th wavelet level, namely

$${κ}_{j} = \frac{{W}_{{A}_{j}}^{x} {W}_{{B}_{j}}^{x} + {W}_{{A}_{j}}^{y} {W}_{{B}_{j}}^{y}}{\sqrt{{( {W}_{{A}_{j}}^{x} )}^{2} + {( {W}_{{A}_{j}}^{y} )}^{2}} \sqrt{{( {W}_{{B}_{j}}^{x} )}^{2} + {( {W}_{{B}_{j}}^{y} )}^{2}}} .$$

Within the context of embodiments of the invention, directional derivations and directional terms are to be understood to mean those wavelet coefficients which are calculated by filtering with the low-pass filter from the wavelet transformation in one spatial dimension and the high-pass filter from the wavelet transformation in the other spatial dimension, respectively. Diagonal derivations and diagonal terms within the context of the invention define those wavelet coefficients which are calculated by filtering with the high-pass filter from the wavelet transformation in all spatial dimensions.

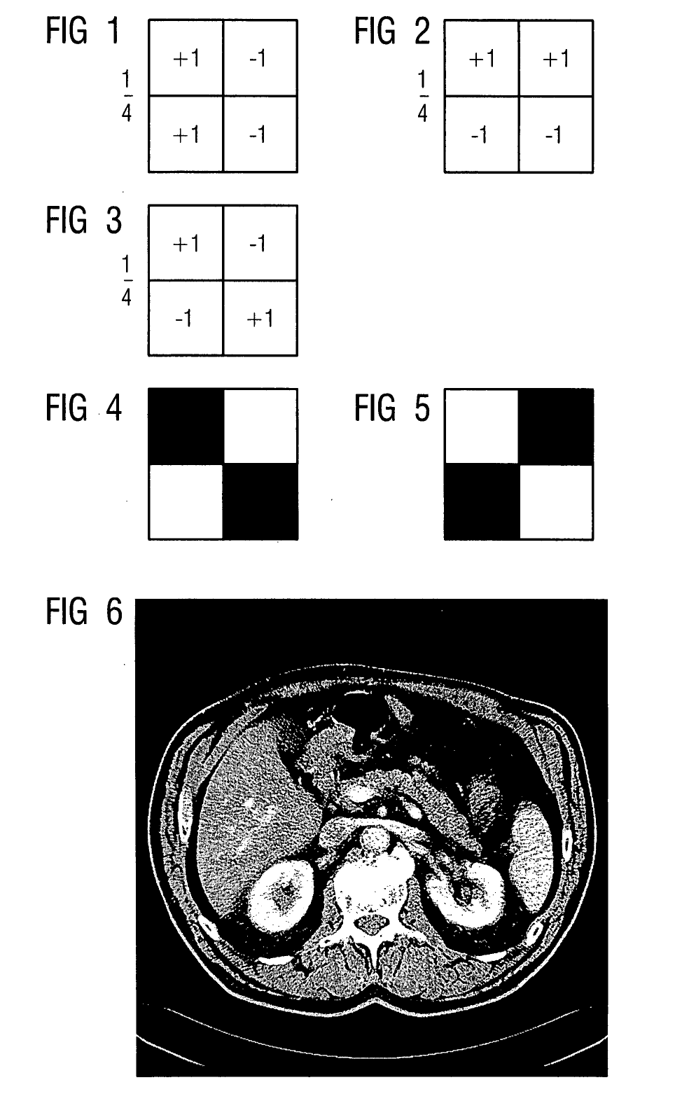

When Haar wavelets are used, such directional derivations are obtained by virtue of the convolution with the cores depicted in FIGS. 1 and 2, for example.

Although only these two magnitudes are used to determine the correlation, the specification DE 103 05 221 A1 proposes downweighting all the high-pass components, that is to say including the diagonal term, which is calculated by the convolution with the core from FIG. 3, in a later step on the basis thereof. Hence, no distinction is drawn between the rating of the correlation between the directional terms (corresponds to the TPxHP and HPxTP groups) and diagonal terms (corresponds to the HPxHP group) and the weighting thereof. However, patterns exist which have tiny directional derivations but are nevertheless correlated. For the Haar wavelet, these are pixel patterns in the form as shown in FIGS. 4 and 5.

As a result of the components which are remote despite the presence of correlation with respect to real structures, image artifacts arise in the form of this pattern on various length scales depending on the level under consideration in the wavelet transformation.

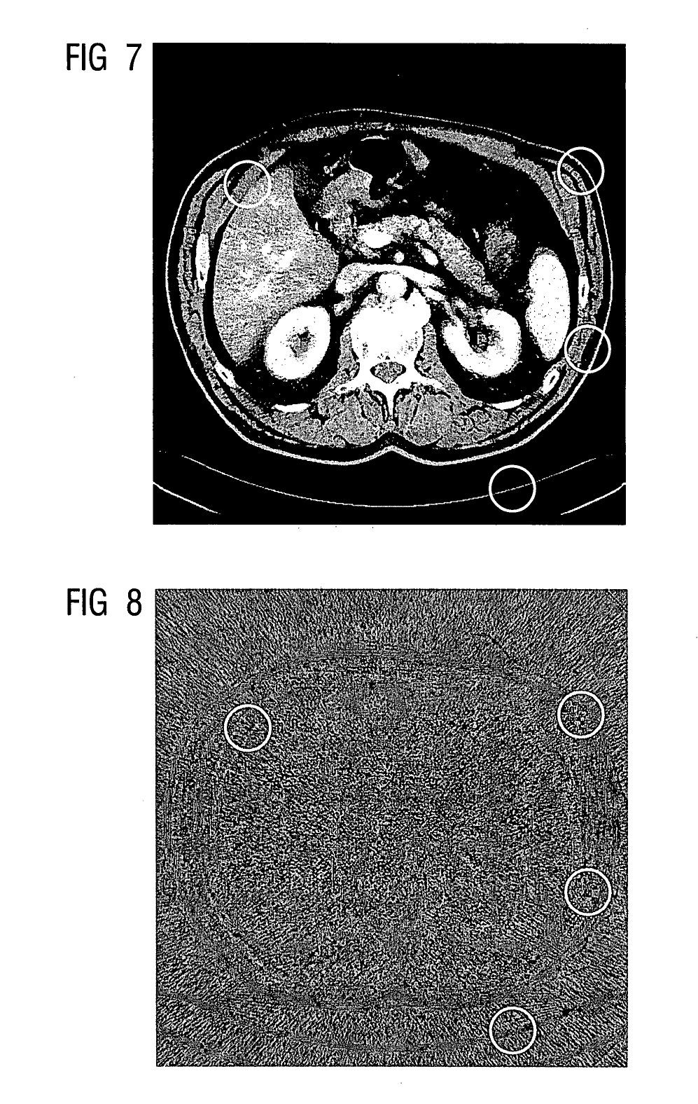

This problem is illustrated by FIGS. 6 and 7 using the example of a CT image. The axial CT image from FIG. 6 has had the noise removed in accordance with the noise reduction method from the patent application with the file reference DE 10 2005 012 654.5 and is shown in FIG. 7. This noise reduction method used here treats the directional terms and the diagonal terms the same during rating and weighting. Accordingly, artifacts are produced at the points marked with circles, which have been produced by actually existing structures and have incorrectly been interpreted as noise and removed during reformatting of the image data record.

This is shown particularly clearly in FIG. 8, which shows a difference image for FIG. 7 minus FIG. 6. The circular markers show artifacts produced as a result of the problem described.

The artifacts shown can be prevented in line with the basic idea of at least one embodiment of the invention only by virtue of the rating of the correlations and the weighting of the wavelet coefficients during the back transformation for the directional terms differing from the rating of the correlations and the weighting of the diagonal terms.

With a tiny or small standard for the vector formed from the directional derivations, the form shown in the specification DE 103 05 221 A1 cannot be used to make a reliable statement about the presence of correlated structures. In addition, despite a small cross correlation function, there may be diagonal components with a high level of correlation. On the basis of the value of the cross correlation function, it is therefore expedient to reduce noise by first of all weighting exclusively the directional derivations.

The diagonal components W_{A}_{ⱼ}^{HPxHP} and W_{B}_{ⱼ}^{HPxHP} are weighted separately on the basis of their correlation analysis. Specifically, this can be done by considering a suitable function of W_{A}_{ⱼ}^{HPxHP} and W_{B}_{ⱼ}^{TPxHP}, where this advantageously depends on the product thereof, and taking account of their contributions to the normalization. To rate the correlations and to weight the diagonal coefficients in the j-th wavelet level, it is possible to use the function

$${κ}_{j}^{HP , HP} = \frac{1}{2} + {( \frac{{W}_{{A}_{j}}^{HP \times HP} {W}_{{B}_{j}}^{HP \times HP}}{{( {W}_{{A}_{j}}^{HP \times HP} )}^{2} + {( {W}_{{B}_{j}}^{HP \times HP} )}^{2}} )}^{{P}_{2}} ∈ [ 0 , 1 ] ,$$

for example, where the exponent P₁ can be used to set the selectivity, W_{A}_{ⱼ}^{HPxHP} is associated with the wavelet coefficient of the image data record A in the level j of the group of purely high-pass filtered wavelet coefficients, and W_{B}_{ⱼ}^{HPxHP} corresponds to the wavelet coefficient of the image data record B in the level j of the purely high-pass filtered wavelet coefficients. In this case, TP and HP are the low- and high-pass filters associated with the wavelet transformations.

As a special case, there merely remains the situation that all directional derivations and diagonal components are simultaneously disappearing or are too small for a stable numerical machine. However, this means that locally neither structures nor significant noise is/are present, which means that the wavelet coefficients can continue to be used unchanged without any drawbacks.

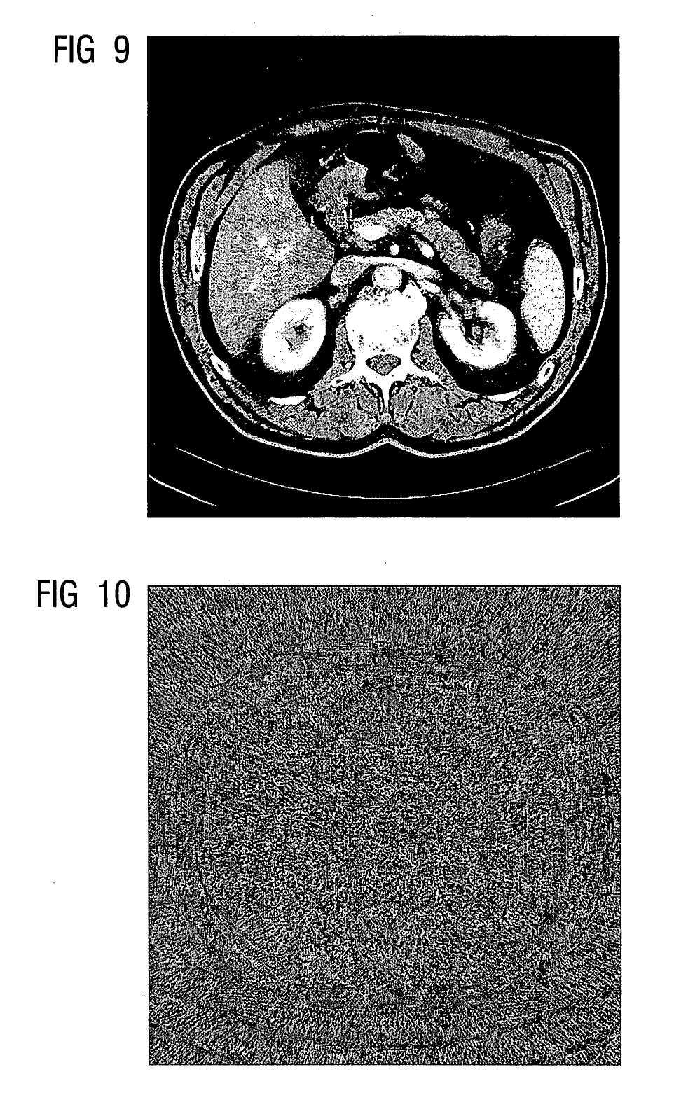

FIG. 9 shows the CT image from FIG. 6 with an embodiment of the inventive noise rejection, the difference image from FIG. 9 minus FIG. 6 being shown in FIG. 10. Here, it is possible to see that the artifacts from the difference image in FIG. 8 have been greatly reduced. Using an embodiment of the inventive method, it is therefore possible to improve the result of noise reduction in relation to the artifacts introduced by the method significantly. This allows more noise to be removed without adversely affecting the relevant image information, or conversely allows more dosage to be spared while the image quality remains the same.

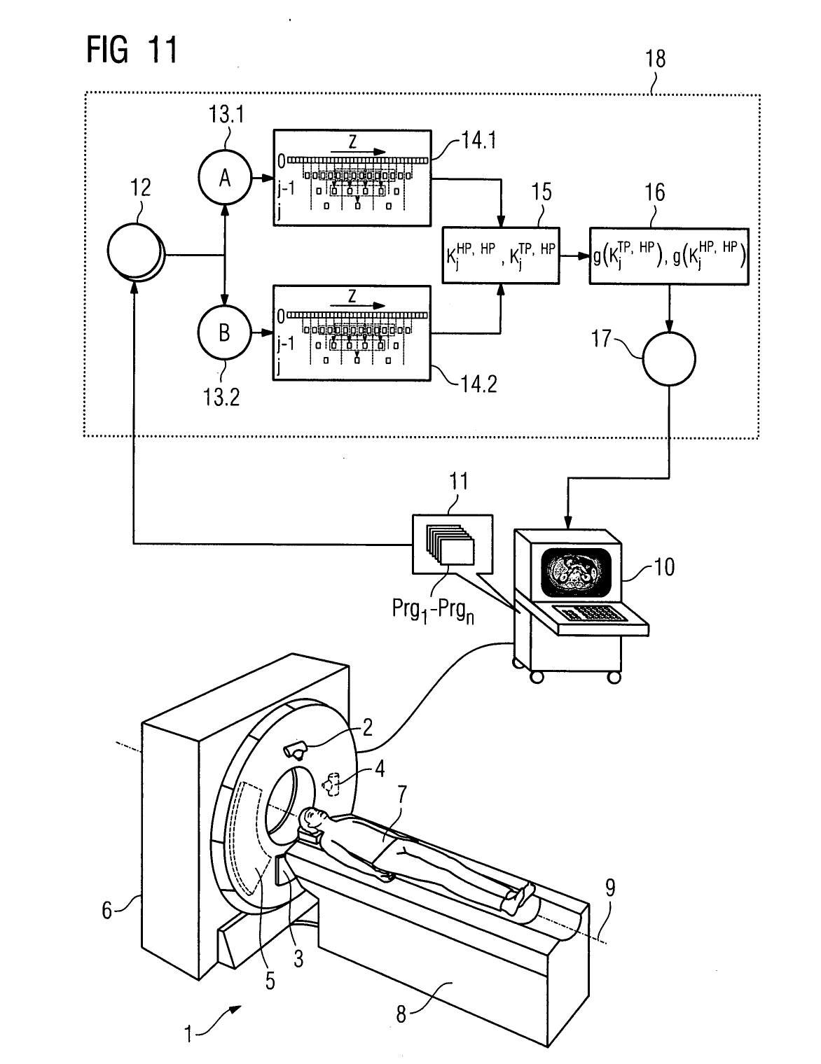

FIG. 11 schematically also shows an exemplary CT system 1 whose processor 10 applies an embodiment of an inventive noise rejection method to CT sectional image displays by executing the programs Prgₓ.

In the case specifically illustrated here, the CT system 1 has a gantry housing 6 in which an X-ray tube 2 and a multirow detector 3 are mounted on the gantry (not shown). During operation, the X-ray tube 2 and the detector 3 rotate around the system axis 9, while the patient 7 is pushed along the system axis 9 through the scanning region between the X-ray tube 2 and the detector 3 using the moveable patient's couch 8. A spiral scan is thus performed relative to the patient. Optionally, a plurality of tube/detector combinations may also be used for scanning. A second tube/detector combination of this kind is indicated in dashes by the second X-ray tube 4 and the second multirow detector 5. It should be noted that a second tube/detector combination can very easily generate a second statistically independent image data record which is statistically independent with respect to the quantum noise.

Control of the CT system and also image reconstruction, including image processing with noise rejection, are effected by the processor 10, which uses an internal memory 11 to hold computer programs Prg₁-Prgₙ which could also be transferred to mobile storage media. Besides the other usual tasks of a CT computer, these computer programs also execute an embodiment of the inventive method for noise rejection during image conditioning.

The schematic illustration in FIG. 11 shows a variant of an embodiment of the inventive noise rejection in the dashed box 18. On this basis, computer programs are first of all used to reconstruct image data records 12 for the patient 7. From these, two statistically independent image data records 13.1 and 13.2 are generated for the same sectional plane and are then subjected to respective wavelet transformation 14.1 and 14.2. In step 15, cross correlation coefficients κⱼ^{TP, HP}, κⱼ^{TP, HP} are then calculated for the calculated wavelet coefficients, and the diagonal terms and the directional terms are indeed considered independently of one another.

Next, in method step 16, the ascertained correlation between the wavelet coefficients in respect of the diagonal terms and the directional terms is taken as a basis for performing weighting for the wavelet coefficients separately from on another during the reformatting of an image data record. In this context, either only the weighted wavelet coefficients for one of the image data records or a combination of the weighted wavelet coefficients from both image data records may be used. In this way, a new image data record 17 from which the quantum noise has been eliminated is produced which in turn can be displayed for assessment by the operating personnel on a display on the processor 10 or else can be transferred to an external computer, a data storage medium or to a printout for further assessment by a doctor.

It should be pointed out that an embodiment of the inventive method can be performed not only on the processors connected directly to an examination system but can also be carried out independently on separate units.

It goes without saying that the features of the invention which have been cited above can be used not just in the respectively indicated combination but also in other combinations or on their own without departing from the scope of the invention.

Overall, at least one embodiment of the invention thus proposes a method for noise reduction in imaging methods, in which two statistically independent image data records in the same situation are generated, are subjected to wavelet transformation characterized by a low-pass filter and a high-pass filter, the correlation between the independent image data records is determined from respectively corresponding wavelet coefficients, and during the back transformation wavelet coefficients with less correlation are given a lower weighting than wavelet coefficients with greater correlation, where the rating of the correlations and the weighting of the wavelet coefficients during the back transformation in the case of wavelet coefficients which have been produced through a combination of high-pass and low-pass filtering are independent of the rating of the correlations and the weighting of the wavelet coefficients during the back transformation of the wavelet coefficients which have been produced through pure high-pass filtering. This allows noise rejection on image data records which cancels out actually existing structures during conditioning less often than in the prior art.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for noise reduction in imaging methods, the method comprising:
generating at least two statistically independent image data records having the same dimensions and being in the same situation;
respectively subjecting the at least two statistically independent image data records to wavelet transformation with low-pass filtering and high-pass filtering over a number j of levels, where:
four groups of wavelet coefficients are calculated in each level,
a TP group of wavelet coefficients is formed by TPXTP operations,
an HP group of wavelet coefficients is formed by HPXHP operations, and
two hybrid groups of the wavelet coefficients are formed by TPXHP operations on the one hand and HPXTP operations on the other hand;
determining a correlation between the at least two statistically independent image data records from a cross correlation function for the respectively corresponding wavelet coefficients of the at least two image data records; and
giving, during back transformation of an image data record from at least one wavelet data record, wavelet coefficients with less correlation a lower weighting than wavelet coefficients with greater correlation, wherein the rating of the correlations and the weighting of the wavelet coefficients during the back transformation within the hybrid groups of the wavelet coefficients differ from the rating of the correlations and the weighting of the wavelet coefficients during the back transformation within the HP group of wavelet coefficients.

2. The method as claimed in claim 1, wherein, during the wavelet transformation, the image data record from the first group is taken as a basis for calculating the next level, and in each level the volume of data in the first group is reduced to one quarter of the initial volume of data.

3. The method as claimed in claim 1, wherein the weighting of the wavelet coefficients during the back transformation of the HP groups is relatively higher than the weighting of the wavelet coefficients of the hybrid groups.

4. The method as claimed in claim 1, wherein the correlation function κⱼ^{TP, HP used within the HP group is the function}
$${κ}_{j}^{TP , HP} = {( \frac{{W}_{{A}_{j}}^{TP \times HP} {W}_{{B}_{j}}^{TP \times HP} + {W}_{{A}_{j}}^{HP \times TP} {W}_{{B}_{j}}^{HP \times TP}}{\sqrt{{( {W}_{{A}_{j}}^{TP \times HP} )}^{2} + {( {W}_{{A}_{j}}^{HP \times TP} )}^{2}} \sqrt{{( {W}_{{B}_{j}}^{TP \times HP} )}^{2} + {( {W}_{{B}_{j}}^{HP \times TP} )}^{2}}} )}^{{P}_{1}} ,$$
where the variables are as follows:
W_{A}_{ⱼ}^{TPxHP}=wavelet coefficient of the image data record A in the level j of the hybrid group TPXHP;
W_{B}_{ⱼ}^{TPxHP}=wavelet coefficient of the image data record B in the level j of the hybrid group TPXHP;
W_{A}_{ⱼ}^{HPxTP}=wavelet coefficient of the image data record A in the level j of the hybrid group HPXTP;
W_{B}_{ⱼ}^{HPxTP}=wavelet coefficient of the image data record B in the level j of the hybrid group HPXTP;
P₁=variable for setting the degree of selection.

5. The method as claimed in claim 1, wherein the correlation function κⱼ^{HP,HP} used within the HP group is the function
$${κ}_{j}^{HP , HP} = \frac{1}{2} + {( \frac{{W}_{{A}_{j}}^{HP \times HP} {W}_{{B}_{j}}^{HP \times HP}}{{( {W}_{{A}_{j}}^{HP \times HP} )}^{2} + {( {W}_{{B}_{j}}^{HP \times HP} )}^{2}} )}^{{P}_{2}} ∈ [ 0 , 1 ] ,$$
where the variables are as follows:
W_{A}_{ⱼ}^{HPxHP}=wavelet coefficient of the image data record A in the level j of the HP group;
W_{B}_{ⱼ}^{HPxHP}=wavelet coefficient of the image data record B in the level j of the HP group;
P₂=variable for setting the degree of selection.

6. The method as claimed in claim 1, wherein a Haar wavelet is used for the wavelet transformation.

7. A method, comprising:
applying the method as claimed in claim 1 in X-ray computer tomography, with at least two statistically independent sectional images being used as image data records in a sectional plane.

8. A method, comprising:
applying the method as claimed in claim 1 in X-ray computer tomography, with two statistically independent projection data records being used as at least two statistically independent image data records, a projection data record from which the noise has been removed is generated from these projection data records, and projection data records from which the noise has been removed which are ascertained in this manner are used to reconstruct sectional images.

9. A method, comprising:
applying the method as claimed in claim 1 in X-ray computer tomography to sectional images in the same sectional plane.

10. A method, comprising:
applying the method as claimed in claim 1 to transmission X-ray images.

11. A method, comprising:
applying the method as claimed in claim 1 in Nuclear Magnetic Resonance tomography.

12. A method, comprising:
applying the method as claimed in claim 1 in Positron Emission Tomography.

13. A method, comprising:
applying the method as claimed in claim 1 in ultrasound imaging.

14. A method, comprising:
applying the method as claimed in claim 1 in ultrasound tomography.

15. A storage medium, at least one of integrated into a processor and for a processor in a tomography system, wherein at least one computer program or program modules is stored thereon which, upon execution on the processor in a tomography system, executes the method as claimed in claim 1.

16. A tomography system, comprising:
a processor, including at least one computer program or program modules stored thereon which, upon execution on the processor in a tomography system, executes the method as claimed in claim 1.

17. The method as claimed in claim 2, wherein the weighting of the wavelet coefficients during the back transformation of the HP groups is relatively higher than the weighting of the wavelet coefficients of the hybrid groups.

18. A computer readable medium including program segments for, when executed on a computer device of a tomography system, causing the tomography system to implement the method of claim 1.
